(19) United States
(12) Patent Application Publication
(10) Pub. No.: US 2024/0070746 A1
(43) Pub. Date: Feb. 29, 2024

(54) MACHINE LEARNING PREDICTION OF USER RESPONSES TO RECOMMENDATIONS SELECTED WITHOUT CONTEXTUAL RELEVANCE

(71) Applicant: Maplebear Inc. (dba Instacart), San Francisco, CA (US)

(72) Inventors: Girija Narlikar, Palo Alto, CA (US); Sharath Rao Karikurve, Berkeley, CA (US)

(21) Appl. No.: 17/899,483

(22) Filed: Aug. 30, 2022

(51) Int. Cl. G06Q 30/06; G06N 20/00; G06Q 30/02

(52) U.S. Cl. CPC G06Q 30/0631; G06N 20/00; G06Q 30/0201; G06Q 30/0633

(57) ABSTRACT

A method implemented at a computer system includes, responsive to identifying an opportunity to present content to a target user, accessing a machine learning model trained on a dataset containing input features of a plurality of users and labels indicating openness metrics of the respective plurality of users. The machine learning model is then applied to a set of features of the target user to output an openness metric that predicts a loss in the target user's response rate when contextual relevance is not considered in selection of recommendation for the target user. A recommendation is then selected from a plurality of candidate recommendations based on the openness metric and sent for display to the target user.

### BACKGROUND

This disclosure relates generally to selecting and displaying recommendations in a user session with an online system, and more specifically to selecting recommendations for a user based at least in part on a metric that indicates a predicted difference in the user's response rate between recommendations that are selected based on their contextual relevance and recommendations that are not selected based on their contextual relevance.

Existing online systems often display contextually relevant content to users. For example, when a user is browsing a particular item at an online system, the online system often suggests or displays other similar or relevant items to the user. Such online systems help users to find what they need, or what may be interesting to them.

However, users are different individuals who have different personalities and have a different openness to discovering new content. Some users have a low tolerance for irrelevant content, as such they would likely have a better response rate for recommendations that are highly relevant to what they are currently doing. But other users are more adventurous, and they may be willing to learn about new things that may be less relevant to what they are currently doing. Alternatively, or in addition, some users tend to browse a fairly static list of items from a first content provider, but tend to be more adventurous with a second content provider. For example, a user may get staple items from a particular retailer, and then become more exploratory with other retailers. As a result, the users who are more open to exploration, or when the users are in the exploring mode, they are likely to have a better response rate to recommendations that are not contextually relevant as compared to users who are less open to discovering new content or items, or when the users are not in the exploring mode.

Existing online systems generally do not understand when users are open to new discovery experiences. In part, this is because there is no reliable way to predict whether a user is open to discovery of content that may not be contextually relevant. Thus, such existing online systems are not able to take advantage of users who are discovery-oriented while avoiding bad experiences for those users who are not.

### SUMMARY

In accordance with one or more aspects of the disclosure, a method, implemented at a computer system, includes applying a machine learning model to a set of features associated with a target user at an online system. The features are indicative of how open a user is to discovering recommendations that are selected for the user without regard to the contextual relevance of the recommendation to the content displayed in the current user session. The model is trained using label that is computed based on a difference between the response rate of the user for recommendations that are selected based on their contextual relevance to a current user session and the response rate of the user for recommendations that are not selected based on their contextual relevance to the current user session. Accordingly, the trained model outputs a metric, based on the input features, that predicts a loss in the user's response rate when contextual relevance is not considered in the selection of a recommendation for the user.

First, the computer system identifies an opportunity to present content to a target user. Responsive to identifying the opportunity to present content to the target user, the computer system accesses a machine learning model and applies the machine learning model to a set of features of the target user to output an openness metric that predicts a loss in the target user's response rate when contextual relevance is not considered in selection of recommendation for the target user. The computer system then selects a recommendation from a plurality of candidate recommendations based on the openness metric and sends the selected recommendation for display to the target user.

In one or more embodiments of the disclosure, the machine learning model is trained on a dataset containing input features of a plurality of users (which may or may not include the target user) and labels indicating openness metrics of the respective plurality of users. The training of the machine learning model includes for each of the plurality of users, displaying a first set of recommendations to the user, where the first set of recommendations are selected based on their contextual relevance, and computing a first response rate to the first set of recommendations. The training also includes for each of the plurality of users, displaying a second set of recommendations, where the second set of recommendations are not selected based on their contextual relevance, and computing a second response rate to the second set of recommendations. After that, an openness metric for each of the plurality of users is computed based on a difference between the first response rate and the second response rate of the corresponding user. The user is then labeled with the openness metric. The openness metric indicates a loss in the user's response rate when contextual relevance is not considered in selection of a recommendation for the user. The training is the performed on the labels corresponding to the openness metric of the plurality of users and their respective sets of input features.

### BRIEF DESCRIPTION OF THE DRAWINGS

FIG. 1 is a block diagram of a system environment in which an online system, such an online concierge system, operates, according to one embodiment.

FIG. 2 illustrates an environment of an online shopping concierge service, according to one embodiment.

FIG. 3 is a diagram of an online shopping concierge system, according to one embodiment.

FIG. 4 is a diagram of one embodiment of using a machine learning user openness model and content selector to recommend and display content on a customer mobile application.

FIG. 5 is a diagram of one embodiment of a modeling engine configured to train a machine learning user openness model based on training datasets.

FIG. 6 is a flowchart of one embodiment of a method for selecting recommendations without contextual relevance using a machine learning model.

FIG. 7 is a flowchart of one embodiment of a method for training a machine learning model.

FIG. 8A illustrates a simplified user interface of an online system, where only relevant content is displayed based on a prediction that a loss in a target user's response rate is relatively high when contextual relevance is not considered in selection of recommendations for the target user.

FIG. 8B illustrates a simplified user interface of an online system, where less relevant content is displayed based on a prediction that a loss in a target user's response rate is relatively low when contextual relevance is not considered in selection of recommendations for the target user.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Architecture

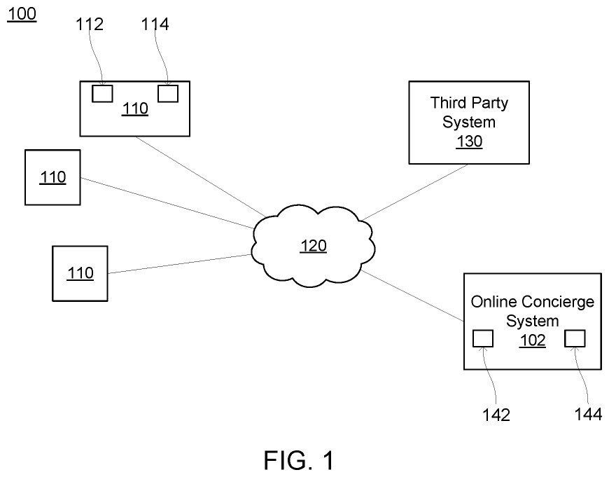

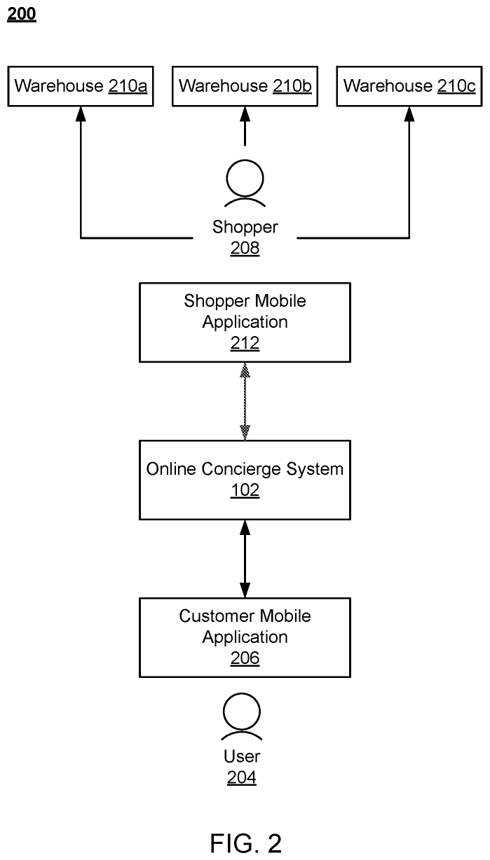

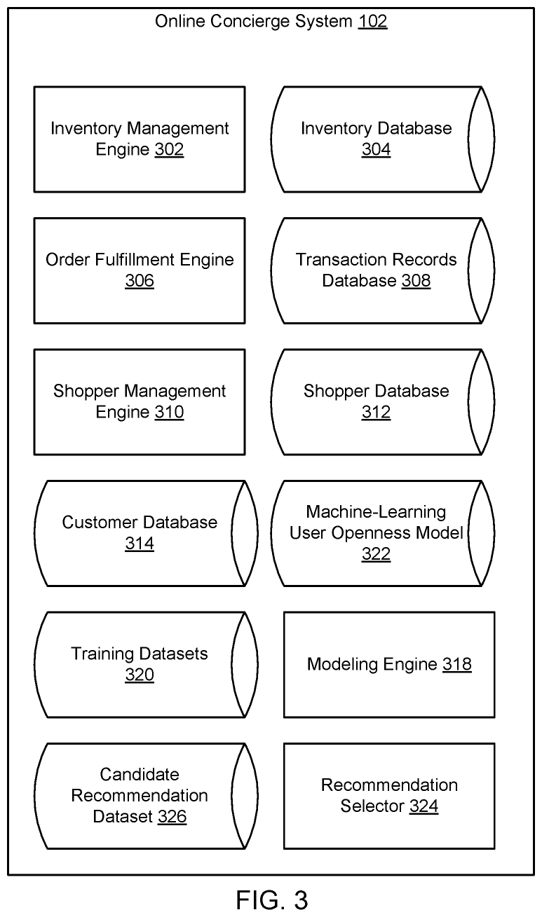

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described above in conjunction with FIGS. 2-7 and 8A-8B. For example, the memory 144 has instructions encoded thereon that, when executed by the processor 142, cause the processor 142 to determine an openness metric of a user, determine relevancies of candidate recommendations to current content displayed in a current user session, and/or select a recommendation from the candidate recommendations based on the openness metric of the user and/or the relevancy of each candidate recommendation. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-7 and 8A-8B, and may include specific computing components such as processors, memories, communication interfaces, and/or the like.

### System Overview

FIG. 2 illustrates an environment 200 of an online platform, such as an online concierge system 102, according to one embodiment. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (items or products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one embodiment. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item, if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the inventory management engine 302 determines a taxonomy of items offered by the warehouse 210. different levels in the taxonomy providing different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Thus, the taxonomy maintains associations between a category and specific items offered by the warehouse 210 matching the category. In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., higher levels include a fewer number of items satisfying a more specific category). The taxonomy may be received from a warehouse 210 in various embodiments. In other embodiments, the inventory management engine 302 applies a trained classification module to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application 206. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

In various embodiments, the order fulfillment engine 306 determines whether to delay display of a received order to shoppers for fulfillment by a time interval. In response to determining to delay the received order by a time interval, the order fulfilment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

In embodiments, the online concierge system 102 also includes a machine learning user openness model 322 trained on training datasets 320 by a modeling engine 318. The training datasets 320 includes input features of a plurality of users and labels indicating openness metrics of the respective plurality of users. In some embodiments, the modeling engine 318 performs the training by, for each of the plurality of users, displaying a first set of recommendations to the user, where the first set of recommendations are selected based on their contextual relevance; and computing a first response rate to the first set of recommendations. The modeling engine 318 also displays a second set of recommendations to the user, where the second set of recommendations are not selected based on their contextual relevance, and computing a second response rate to the second set of recommendations. The modeling engine 318 then computes an openness metric that is a function of a difference between the first response rate and the second response rate. The openness metric indicates a loss in the user's response rate when contextual relevance is not considered in selection of a recommendation for the user. The modeling engine 318 then labels the users with their respective openness metrics. The modeling engine 318 then trains the machine learning user openness model 322 on the labels corresponding to the openness metrics of the plurality of users and their respective sets of input features.

When the online concierge system 102 identifies an opportunity to present content to a target user, the machine learning user openness model 322 is applied to a set of input features of the target user to output an openness metric that predicts a loss in the target user's response rate when contextual relevance is not considered in selection of recommendation for the target user.

The online concierge system 102 also includes a candidate recommendation dataset 326 and a recommendation selector 324. The recommendation selector 324 is configured to select a recommendation from the candidate recommendation dataset 326, and send the selected recommendation for display to the target user. In some embodiments, the recommendation selector 324 is also configured to identify content that the target user is currently viewing, and select or recommend a piece of content from the candidate recommendation dataset 326 based on the openness metric and the content that the user is currently viewing.

In some embodiments, the target user may be a customer or a potential customer of the online concierge system 102. The candidate recommendation dataset 326 may store various pieces of content that are related to the products sold by retailers of the online concierge system 102. For example, when the machine learning user openness model 322 outputs an openness metric predicting that the target user is unlikely to respond to content when contextual relevance of the content is not considered, the recommendation selector 324 may identify a first product that the customer is currently viewing or is placed in a shopping cart, select a second product that is sufficiently relevant to the first product, and recommend the second product to be displayed to the target user. On the other hand, when the machine learning user openness model 322 outputs an openness metric predicting that the target user is likely to respond to content regardless of the contextual relevance, the recommendation selector 324 may select and recommend a third product randomly regardless of relevancy of the third product to the first product.

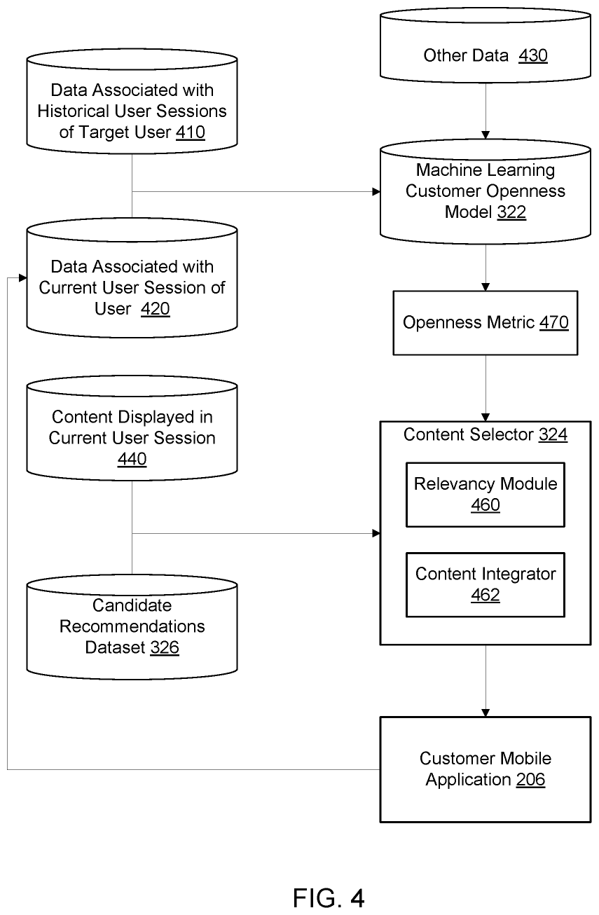

Additional details about the machine learning user openness model 322, training datasets 320, candidate recommendation dataset 326, and recommendation selector 324 are further discussed below with respect to FIGS. 4-7.

### Machine Learning User Openness Model

FIG. 4 is a diagram of using machine learning user openness model 322 and recommendation selector 324 to recommend and display content at customer mobile application 206. As briefly discussed above, when the online concierge system 102 identifies an opportunity to present content to a target user, the machine learning user openness model 322 is applied to a set of input features of the target user to output an openness metric that predicts a loss in the target user's response rate when contextual relevance is not considered in selection of recommendation for the target user.

The set of input features of the target user may include (but are not limited to) data associated with historical user sessions 410 of the target user, data associated with a current user session 420 of the target user, and/or other data 430 with the target user.

For example, data associated with historical user sessions 410 of the target user may include (but is not limited to) (1) a piece of content displayed in the historical user sessions, (2) whether the user clicked the piece of content, (3) an amount of time that the user is reviewing the piece of content after clicking it, (4) whether the piece of content was selected by the computer system, (5) whether the user places an item associated with the piece of content in a shopping cart, (6) whether the user keeps the item in the shopping cart at an end of a user session, (7) whether the user removes the item from the shopping cart before the end of the user session, (8) whether the user purchases the item before the end of the user session, (9) an amount of the item that the user places in the shopping cart, (10) an amount of the item that the user purchases, (11) an average time the user spent on each user session, (12) a click-through rate of the user indicating a number or ratio of suggested content that the user had clicked through, (13) how often the user explores or purchases a new product or a product of a new brand in the historical user sessions, or (14) how often the user explores or purchases a new product or a product of a new brand from a particular retailer.

The data associated with the current user session 420 of the target user may include (but is not limited to) (1) a search query entered by the user during the current user session, (2) a variety of content browsed by the user during the current user session, or (3) a variety of items that are placed in a shopping cart by the user.

The other data 430 may include (but is not limited to) data input by the user indicating their openness, and/or metadata associated with the user. For example, data input by the user may include (but is not limited to) a survey that the user has taken to indicate whether the user is willing to receive suggestions about new products. Metadata associated with the user may include (but is not limited to) the data associated with the user profile at the online concierge system 102 or other third-party systems, such as user's geolocation, job title, education, age, gender, etc.

In some embodiments, the set of input features 410, 420, 430 of the target user may be at least partially stored in the customer database 314. In some embodiments, the set of input features 410, 420, 430 of the target user may be at least partially stored in another data source which may or may not be internal to the online concierge system 102.

The machine-learned customer openness model 322 is configured to retrieve or obtain the set of features 410, 420, 430 of the target user from the customer database 314 and/or other data sources, and take the set of features as input to generate an output an openness metric 470, that predicts a loss in the target user's response rate when contextual relevance is not considered in selection of recommendation for the target user.

For example, if the target user often browses through a large number of items for a long time before purchasing one of the browsed items, the machine learning user openness model 322 may determine that the user is generally open to new or less relevant content. As another example, if the user spends very little time browsing and always purchases the same items, the machine learning user openness model 322 may determine that the user is generally not very open to new or less relevant content.

As another example, when a search query entered by the target user in the current user session is very specific, e.g., organic fat free milk of a particular brand, the machine learning user openness model 322 may determine that the user is not very open to new or less recommendations at the moment. On the other hand, when the search query is fairly general, e.g., dinner, the machine learning user openness model 322 may determine that the user is fairly open to new or less relevant recommendations at the moment.

In some embodiments, the machine learning user openness model 322 is further configured to compare values of a first set of features associated with the historical user sessions of the target user 410 with values of a second set of features associated with the current user sessions of the target user 420 to determine whether current user's behavior deviates from historical user's behavior of the same target user. The determination of the openness metric of the user is further based on the comparison. For example, if the current user's behavior deviates from the historical user's behavior by more than a predetermined threshold, the features associated with the current user session may be given a greater weight than the features associated with historical user sessions; otherwise, the features associated with the historical user sessions are given similar or greater weight than the features associated with the current user session.

The determined openness metric 470 of the target user may be a scale of numeric values (e.g., 1 to 10), by a few discrete levels (e.g., low, medium, high), or by a binary flag (e.g., 0 indicating open, and 1 indicating not open). In some embodiments, the machine learning user openness model 322 assigns different weights for features associated with historical user sessions 410 of the target user, features associated with current user session 420 of the target user, and/or the other relevant features 430; and generates a single openness metric based on the weighted features.

In some embodiments, the machine learning user openness model 322 generates a first metric and/or a second metric indicating the general openness of the user based on the features associated with the historical user sessions 410 and/or the other relevant features 430, and generates a third metric indicating the current openness of the user based on the features associated with the current behavior of the user 420 in the current user session. In some embodiments, the first metric, the second metric, and/or the third metric are integrated into an overall openness metric 470. For example, in some embodiments, each of the first metric, the second metric, and the third metric is assigned different weights, and the first metric, the second metric, and/or the third metric are aggregated to generate an overall openness metric based on a weighted average. In some embodiments, the third metric associated with the current user session are generally assigned weights greater than the first and/or second metric associated with the historical user sessions and/or general openness of the user.

After the openness metric 470 is determined, the openness metric 470 is passed to the recommendation selector 324. The recommendation selector 324 has access to candidate recommendation dataset 326 that stores a plurality of pieces of content that may be displayed at customer mobile application 206 of the target user. The recommendation selector 324 receives the openness metric 470 output by the machine learning openness model 322, selects content from the candidate recommendation dataset 326 based on the openness metric 470, and recommends the selected content to be displayed in the customer mobile application 206 for the target user.

As another example, in some embodiments, when the openness of the user is greater than a predetermined threshold, less relevant recommendations may be selected to be displayed. In some embodiments, when the openness of the user is greater than the predetermined threshold, the recommendation selector 324 randomly selects one or more recommendations from the candidate recommendation dataset 326, regardless of their relevancy to the content displayed in the current user session 440 of the target user.

On the other hand, when the openness score 470 is no higher than the predetermined threshold, the recommendation selector 324 may select a recommendation from the candidate recommendation dataset 326 that is sufficiently relevant to the content displayed in the current user session 440. In some embodiments, the recommendation selector 324 includes a relevancy module 460 configured to compare candidate recommendations (stored in the candidate recommendation dataset 326) and content displayed in the current user session 440 to determine a relevancy score therebetween.

In some embodiments, each candidate recommendation in the candidate recommendations dataset 326 or the content displayed in the current user session 440 is associated with one or more parameters. For example, when the candidate recommendation is related to products sold via the online concierge system 102, the parameters may include (but are not limited to) category (e.g., dairy), subcategory (e.g., milk), a retailer, a brand of the product. The content associated with the current user session is also associated with the parameters. The relevancy score between each recommendation in the candidate recommendation dataset 326 and the content displayed in the current user session 440 is computed based on the value of the one or more parameters corresponding to the recommendations in the candidate recommendation dataset 326 and the content displayed in the current user session 440.

The relevancy score indicates how relevant the piece of content is to the content displayed in the current user session. The relevancy score of the pieces of content may be a scale of numeric values (e.g., 1 to 10), by a few discrete levels (e.g., low, medium, high), or by a binary flag (e.g., 0 indicating relevant, and 1 indicating irrelevant).

Generally, a higher openness metric indicates that the user is more open to discovery of new or less relevant content. As such, in some embodiments, a higher openness metric corresponds to a lower contextual relevancy score of the selected content. For example, the more open the user is, the less relevant content may be selected and recommended for display to the target user.

In some embodiments, the recommendation selector 324 also includes a content integrator 462. Once the recommendation(s) (which may be relevant or less relevant to the content displayed in the current user session) are selected, the selected recommendations are then sent to a content integrator 462. The content integrator 462 is configured to integrate the selected recommendation(s) into the content currently displayed in the current user session 440.

In some embodiments, the integration of the selected recommendation may also be based on the openness metric 470 and/or relevancy of the selected recommendation. For example, depending on the relevancy of the recommendation(s), the content integrator 462 may format the recommendation(s) differently and/or place the recommendation(s) at different locations relevant to the content of the current user session. For example, in some embodiments, the content integrator 462 may format the more relevant recommendation in a larger format and place them at a more prominent location on the user interface or closer to the original content displayed in the current user session 440, while the less relevant recommendation may be formatted in a smaller format and placed at a less prominent location or further away from the original content displayed in the current user session 440; or vice versa.

The content integrator 462 then causes the recommendations to be integrated and displayed to the target user in a customer mobile application 206, which may be a mobile app or a web browser. When the target user is viewing the pieces of content (selected based on relevancy or not based on relevancy) displayed at the customer mobile application 206, the target user may or may not click any piece of content, and/or purchase or not purchase any item associated with a piece of content. In some embodiments, the behavior of the user after presenting the pieces of content may then be added to the data associated with the current user session 420, and the machine learning user openness model 322 uses the updated data associated with the current user session 420 to update the values of the features associated with the current user session. The updated values of the features are then used to determine an updated openness metric 470 for the target user, which may then be use by the recommendation selector 324 to select another recommendation to be displayed in the user session. This process can repeat as many times as necessary as the user session continues. As such, desirable content is shown to the user based on the target user's feedback during the user session.

Machine Learning Factors Associated with Machine Learning User Openness Model

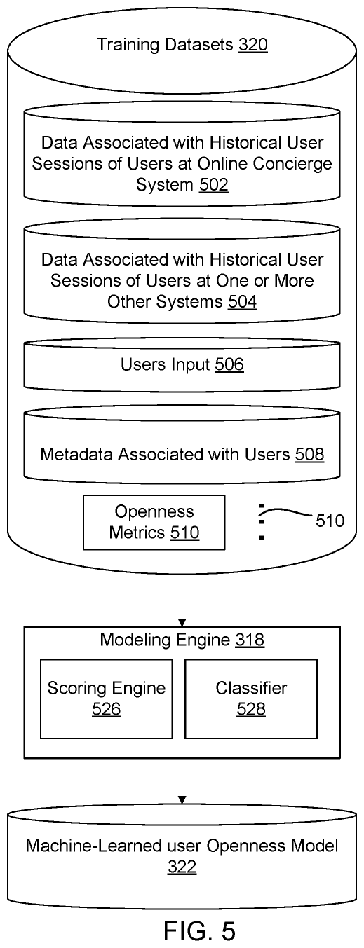

FIG. 5 is a diagram of the modeling engine 318 configured to train the machine learning user openness model 322 based on training datasets 320. The training datasets 320 include features 502, 504, 506, 508 of a plurality of users and openness metrics 510 of the respective plurality of users. In some embodiments, the features of the plurality of users include data 502 associated with historical user sessions of a plurality of users at the online concierge system, data 504 associated with historical user sessions of the plurality of users at one or more other systems, a dataset 506 obtained from input by the plurality of users, and/or metadata 508 associated with the plurality of users. The ellipsis 510 represents that there may be additional or different datasets that are used as training datasets 320.

In some embodiments, obtaining the openness metrics 510 includes, for each of the plurality of users, displaying a first set of recommendations to the user, where the first set of recommendations are selected based on their contextual relevance; computing a first response rate to the first set of recommendations; displaying a second set of recommendations to the user, where the second set of recommendations are not selected based on their contextual relevance; and computing a second response rate to the second set of recommendations. For each of the plurality of users, an openness metric can then be computed based on a function of a difference between the first response rate and the second response rate, and the user is labeled with the openness metric. The openness metric indicates a loss in the user's response rate when contextual relevance is not considered in selection of a recommendation for the user.

In some embodiments, the one or more features associated with historical user sessions 502, 504 of the plurality of users include (1) a plurality of pieces of content displayed in the historical user sessions of a plurality of users, (2) whether each of the plurality of users clicked the piece of content, (3) an amount of time that each of the plurality of users is reviewing the piece of content after clicking it, (4) whether the piece of content was selected by the computer system, (5) whether each of the plurality of users places an item associated with the piece of content in a shopping cart, (6) whether each of the plurality of users keeps the item in the shopping cart at an end of a user session, (7) whether each of the plurality of users removes the item from the shopping cart before the end of the user session, (8) whether each of the plurality of users purchases the item before the end of the user session, (9) an amount of the item that each of the plurality of users places in the shopping cart, (10) an amount of the item that each of the plurality of users purchases, (11) an average time each of the plurality of users spent on each user session, (12) a click-through rate of each of the plurality of users indicating a number or ratio of suggested content that each of the plurality of users had clicked through, (13) how often each of the plurality of users explores or purchases a new product or a product of a new brand in the historical user sessions, or (14) how often each of the plurality of users user explores or purchases a new product or a product of a new brand from a particular retailer.

In some embodiments, the modeling engine 318 trains machine learning model 322 to correlate the features 502, 504, 506, 508 with the openness metrics 510. In some embodiments, the modeling engine 318 includes a scoring engine 526 configured to train machine learning model 322 to take a set of features of a target user as input to generate a numeric openness score. The higher the score indicates a lower loss in the target user's response rate when contextual relevance is not considered in selection of recommendation for the target user, and vice versa. In some embodiments, the openness scores are then divided into multiple categories; each category represents a discrete openness level, such as very open, medium open, not open, etc.

In some embodiments, the modeling engine 318 includes a classifier engine 528 configured to train machine learning model 322 to take a set of features of a target user as input to generate a binary openness metric. The binary 1 indicates that the target user is open to new or less relevant content, and 0 indicates that the target user is not open to new or less relevant content.

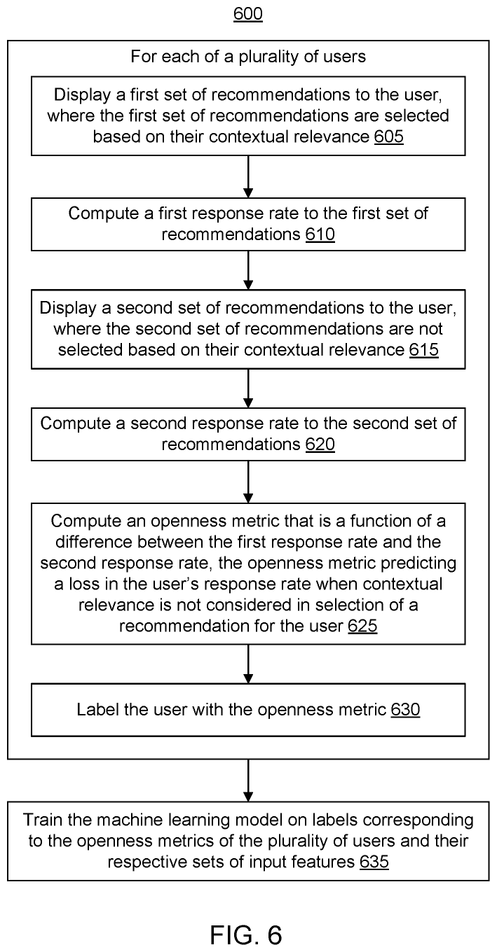

FIG. 6 is a flowchart of one embodiment of a method 600 for training a machine learning model (corresponding to the machine learning openness model 322). In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments, while in other embodiments, the steps of the method are performed by any online system capable of retrieving items.

For each of a plurality of users, the online concierge system 102 displays 605 a first set of recommendations to the user, where the first set of recommendations are selected based on their contextual relevance, and computes 610 a first response rate to the first set of recommendations. The online concierge system 102 also displays 615 a second set of recommendations to the user, where the second set of recommendations are not selected based on their contextual relevance, and computes 620 a second response rate to the second set of recommendations. Note, the first set of recommendations and the second set of recommendations may be displayed to different users in any sequence or randomly. In some embodiments, a user session of a user may be randomly selected, and the user is randomly shown one or more of the first set of recommendations and/or one or more of the second set of recommendations. In some embodiments, recommendations in both sets are simultaneously shown to a same user to measure the user's response to each set of recommendations.

The online concierge system 102 then computes 625 an openness metric that is a function of a difference between the first response rate and the second response rate. The openness metric predicts a loss in the user's response rate when contextual relevance is not considered in selection of a recommendation of the user. The online concierge system 102 then labels 630 the user with the openness metric. Finally, the online concierge system 102 trains 635 the machine learning model on labels corresponding to the openness metrics of the plurality of users and their respective sets of input features. The machine learning model is trained to take a set of features of a target user as input to output an openness metric that predicts a loss in the target user's response rate when contextual relevance is not considered in selection of a recommendation for the user.

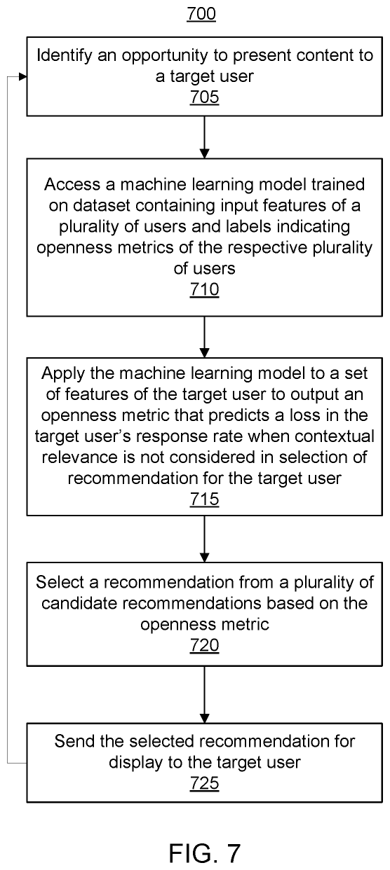

FIG. 7 is a flowchart of one embodiment of a method 700 for selecting recommendations without contextual relevance using a machine learning model (corresponding to the machine learning user openness model 322). In various embodiments, the method includes different or additional steps than those described in conjunction with FIG. 7. Further, in some embodiments, the steps of the method may be performed in different orders than the order described in conjunction with FIG. 7. The method described in conjunction with FIG. 7 may be carried out by the online concierge system 102 in various embodiments, while in other embodiments, the steps of the method are performed by any online system capable of retrieving items.

In some embodiments, the online concierge system 102 is configured to identify 705 an opportunity to present content to a target user. For example, an opportunity may be identified when the target user enters a search query for a product or a type of products, when the target user reviews additional details about the product (e.g., calorie, ingredient of a food product), and/or when the target user places a product into their shopping cart.

Responsive to identifying 705 an opportunity to present content to the target user, the online concierge system 102 accesses 710 a machine learning model trained on a dataset (e.g., training datasets 320) containing input features (e.g., datasets 502, 504, 506) of a plurality of users and labels indicating openness metrics (e.g., openness metrics 510) of the respective plurality of users.

The online concierge system 102 then applies 715 the machine learning model to a set of features (e.g., dataset 410, 420, 430) of the target user to output an openness metric (e.g., openness metric 470) that predicts a loss in the target user's response rate when contextual relevance is not considered in selection of recommendation for the target user. In some embodiments, the set of features of the target user may include data associated with historical user sessions. Alternatively, or in addition, the set of features of the target user includes data associated with the current user sessions of the target user.

The online concierge system 102 then selects 720 a recommendation from a plurality of candidate recommendations based on the openness metric. For example, when the openness metric indicates that a loss rate in the target user's response rate is lower than a predetermined threshold when contextual relevance is not considered in selection of recommendation for the target user, a recommendation may be randomly selected regardless of its relevancy to the content currently displayed in the user session. On the other hand, when the openness metric indicates that a loss rate is higher than the predetermined threshold when contextual relevance is not considered, a recommendation that is highly relevant to the content currently displayed in the user session may be selected.

In some embodiments, when the user is a new user, no feature associated with historical user sessions of the user or current user session of the new user is available. An openness metric of the new user is set as a default value, which may be one of (1) a lowest openness metric, (2) a highest openness metric, (3) an average openness metric of a plurality of existing users, or (4) a median openness metric of the plurality of existing users.

Finally, the online concierge system 102 sends 725 the selected recommendation for display to the target user (e.g., at customer mobile application 206 of the target user). In some embodiments, the online concierge system 102 integrates the selected recommendation with the original content displayed in the user session based on the openness metric of the target user and/or the relevancy of the recommendation. For example, a highly relevant recommendation may be displayed at a more prominent place, closer to the original content, and/or in a larger form, and a less relevant recommendation may be displayed at a less prominent place, further away from the original content, and/or in a smaller form.

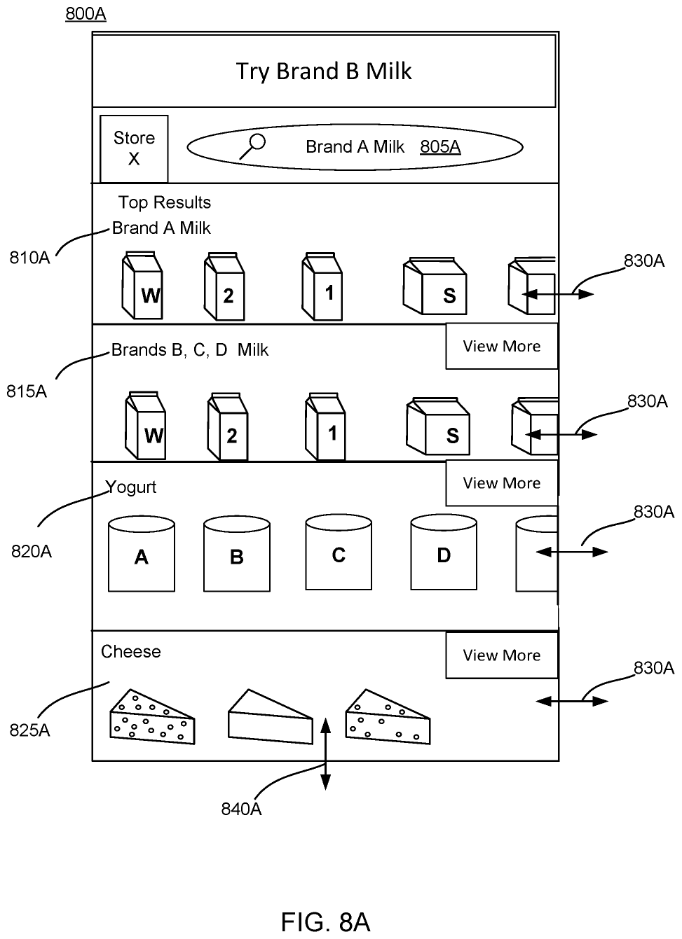

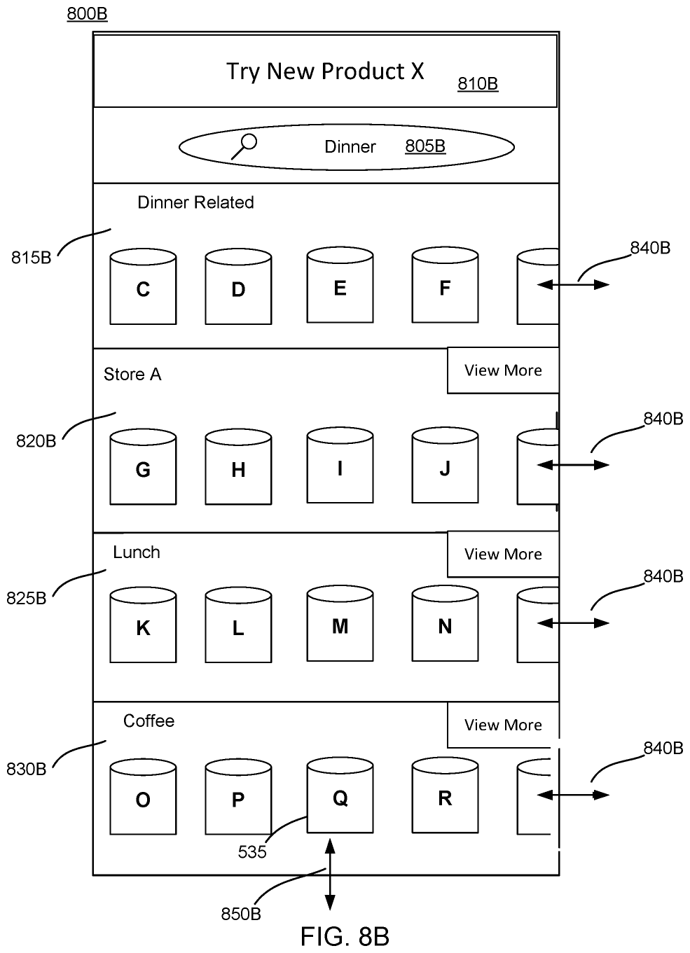

FIGS. 8A-8B illustrate simplified user interfaces 800A and 800B according to some embodiments. Referring to FIG. 8A, a user typed “brand A milk” in the search box 805A. This search query is fairly specific. Based on the search query, the machine learning user openness model 322 may determine that the user's openness metric is 3 out of 10, indicating that the user is not very open to less relevant content. Based on the openness metric 3, the recommendation selector 324 selects a few recommendations 810A, 815A, 820A, 825A and causes the recommendations 810A, 815A, 820A, 825A to be displayed in the user interface 800A as four rows. Notably, the recommendations 810A include brand A milk, which very relevant (exactly matches) the user's query. The recommendations 815A include other brands (e.g., brands B, C, D's milk), which are still fairly relevant. The recommendations 820A and 825A are yogurt and cheese, which are somewhat relevant as they are all dairy products.

The more relevant recommendations 810A and 815A are displayed at a location closer to the search box 805A, and the less relevant recommendations 820A and 825A are displayed further away from the search box 805A. As illustrated in FIG. 8A, the rows of recommendations 810A, 815A, 820A, 825A are scrollable horizontally, represented by arrows 830A. The user can also further scroll down to discover additional content, represented by arrow 840A. When the user further scrolls right, or down, the machine learning user openness model 322 may update the user's openness metric to a higher value (e.g., from 3 to 5) based on the user action, because the scrolling action indicates that the user is likely open to discovery of new recommendations, and the recommendation selector 324 may select additional recommendations (which may be less relevant to brand A milk) based on the updated openness metric for the user to view.

Referring to FIG. 8B, a user typed “dinner” in the search box 805B. This search query is fairly broad. Based on the search query, the machine learning user openness model 322 may determine that the user's openness metric is 8 out of 10, indicating that the user is very open to new or less relevant content. Based on the openness metric 8, the recommendation selector 324 selects recommendations 810B, 815B, 820B, 825B, and 830B, and causes these recommendations to be displayed in the user interface 800B. Notably, the recommendation 810B is displayed as a banner, stating “try new product X,” prominently placed at the top of the user interface 800B. The new product X (which may or may not be related to dinner at all) is displayed at a very prominent location, next to the search box 805B. The recommendations 815B are products related to dinner, which are relevant to the user's search query, while the rest of recommendations 820B, 825B, 830B are not very relevant to the user's search query. For example, the recommendations 820B are products sold by store A, the recommendations 825B are products related to lunch, and the recommendations 830B are products related to coffee.

The user may or may not be interested in the recommendations 810B, 820B, 825B, 830B. Whether the user is open to further suggestions may be inferred based on the user's interaction with the selectively displayed recommendations 810B, 820B, 825B, 830B. If the user clicks a coffee product in recommendation 830B, the machine learning user openness model 322 may increase the user's openness metric from 8 to 9 because clicking something less relevant indicates that the user is very open to discovery of new or less relevant content. When the coffee product is selected by and shown to the user, the recommendation selector 324 may select additional less relevant recommendations for the user to view. On the other hand, if the user clicks one of the dinner product in recommendation 815B, the machine learning user openness model 322 may decrease the user's openness metric from 8 to 6 because the user appears to be only interested in the searched items (i.e., dinner items). Similar to the user interface 800A, the user interface 800B is also scrollable horizontally and/or vertically, represented by arrows 840B and 850B. When the user scrolls horizontally and/or vertically, the user's action may also cause the machine learning user openness model 322 to update the user's openness score, which in turn causes the recommendation selector 324 to select new content for the user to view.

### Additional Considerations

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which include any type of tangible media suitable for storing electronic instructions and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising, at a computer system comprising at least one processor and memory:
identifying an opportunity to present content to a target user;
responsive to identifying the opportunity to present content to the target user, accessing a machine learning model trained on a dataset containing input features of a plurality of users and labels indicating openness metrics of the respective plurality of users, wherein training the machine learning model comprises:
for each of the plurality of users,
displaying a first set of recommendations to the user, where the first set of recommendations are selected based on their contextual relevance;
computing a first response rate to the first set of recommendations;
displaying a second set of recommendations to the user, where the second set of recommendations are not selected based on their contextual relevance;
computing a second response rate to the second set of recommendations;
computing an openness metric that is a function of a difference between the first response rate and the second response rate, the openness metric indicating a loss in the user's response rate when contextual relevance is not considered in selection of a recommendation for the user; and
labeling the user with the openness metric; and
training the machine learning model on labels corresponding to the openness metrics of the plurality of users and their respective sets of input features;
applying the machine learning model to a set of features of the target user to output an openness metric that predicts a loss in the target user's response rate when contextual relevance is not considered in selection of recommendation for the target user;
selecting a recommendation from a plurality of candidate recommendations based on the openness metric; and
sending the selected recommendation for display to the target user.

2. The method of claim 1, where selecting the recommendation from a plurality of candidate recommendations comprises:
identifying content currently displayed to the target user;
determining relevancies of the plurality of candidate recommendations to the content currently displayed to the target user; and
selecting a recommendation based on the relevancies and openness metric of the target user.

3. The method of claim 2, wherein selecting the recommendation from the plurality of candidate recommendations based on the openness metric comprises scoring each of the candidate recommendations by modifying a contextual relevance component of the candidate recommendation based on the openness metric for the target user.

4. The method of claim 3, further comprising:
in response to determining that the openness metric of the target user is greater than a first threshold, selecting at least one candidate recommendation that has a relevancy less than a second threshold.

5. The method of claim 3, further comprising:
in response to determining that the openness metric of the target user is no greater than a first threshold, selecting at least candidate recommendation that has a relevancy no less than a second threshold.

6. The method of claim 1, wherein the set of features of the target user comprises data associated with a current user session of the target user.

7. The method of claim 6, wherein the data associated with historical user sessions of the target user comprise at least one of (1) a piece of content displayed in the historical user sessions, (2) whether the target user clicked the piece of content, (3) an amount of time that the target user is reviewing the piece of content after clicking it, (4) whether the piece of content was selected by the computer system, (5) whether the target user places an item associated with the piece of content in a shopping cart, (6) whether the target user keeps the item in the shopping cart at an end of a user session, (7) whether the target user removes the item from the shopping cart before the end of the user session, (8) whether the target user purchases the item before the end of the user session, (9) an amount of the item that the target user places in the shopping cart, (10) an amount of the item that the target user purchases, (11) an average time the target user spent on each user session, (12) a click-through rate of the target user indicating a number or ratio of suggested content that the target user had clicked through, (13) how often the target user explores or purchases a new product or a product of a new brand in the historical user sessions, or (14) how often the target user explores or purchases a new product or a product of a new brand from a particular retailer.

8. The method of claim 6, wherein the data associated with the current user session of the target user comprise at least one of (1) a search query entered by the target user during the current user session, (2) a variety of content browsed by the target user during the current user session, or (3) a variety of items that are placed in a shopping cart by the target user.

9. The method of claim 1, wherein displaying the first set of recommendations to the user comprises:
receiving a search query from the user;
selecting one or more recommendations based on a relevance to the received search query; and
displaying the selected one or more recommendations in connection with a set of search results responsive to the search query.

10. The method of claim 1, wherein displaying the first set of recommendations to the user comprises:
providing a page of content to the user;
selecting one or more recommendations based on a relevance to the page of content; and
displaying the selected one or more recommendations in connection with the displayed page of content.

11. A computer program product comprising a non-transitory computer readable storage medium having instructions encoded thereon that, when executed by a processor, cause the processor to:
identify an opportunity to present content to a target user;
responsive to identifying the opportunity to present content to the target user, access a machine learning model trained on a dataset containing input features of a plurality of users and labels indicating openness metrics of the respective plurality of users, wherein training the machine learning model comprises: for each users,
display a first set of recommendations to the user, where the first set of recommendations are selected based on their contextual relevance;
compute a first response rate to the first set of recommendations;
display a second set of recommendations to the user, where the second set of recommendations are not selected based on their contextual relevance;
compute a second response rate to the second set of recommendations;
compute an openness metric that is a function of a difference between the first response rate and the second response rate, the openness metric indicating a loss in the user's response rate when contextual relevance is not considered in selection of a recommendation for the user; and
label the user with the openness metric; and
train the machine learning model on labels corresponding to the openness metrics of the plurality of users and their respective sets of input features;
apply the machine learning model to a set of features of the target user to output an openness metric that predicts a loss in the target user's response rate when contextual relevance is not considered in selection of recommendation for the target user;
select a recommendation from a plurality of candidate recommendations based on the openness metric; and
send the selected recommendation for display to the target user

12. The computer program product of claim 11, where selecting the recommendation from a plurality of candidate recommendations comprises:
identifying content currently displayed to the target user;
determining relevancies of the plurality of candidate recommendations to the content currently displayed to the target user; and
selecting a recommendation based on the relevancies and openness metric of the target user.

13. The computer program product of claim 12, wherein selecting the recommendation from the plurality of candidate recommendations based on the openness metric comprises scoring each of the candidate recommendations by modifying a contextual relevance component of the candidate recommendation based on the openness metric for the target user.

14. The computer program product of claim 13, further comprising:
in response to determining that the openness metric of the target user is greater than a first threshold, selecting at least one candidate recommendation that has a relevancy less than a second threshold.

15. The computer program product of claim 13, further comprising:
in response to determining that the openness metric of the target user is no greater than a first threshold, selecting at least candidate recommendation that has a relevancy no less than a second threshold.

16. The computer program product of claim 11, wherein the set of features of the target user comprises data associated with a current user session of the target user.

17. The computer program product of claim 16, wherein the data associated with historical user sessions of the target user comprise at least one of (1) a piece of content displayed in the historical user sessions, (2) whether the target user clicked the piece of content, (3) an amount of time that the target user is reviewing the piece of content after clicking it, (4) whether the piece of content was selected by the processor, (5) whether the target user places an item associated with the piece of content in a shopping cart, (6) whether the target user keeps the item in the shopping cart at an end of a user session, (7) whether the target user removes the item from the shopping cart before the end of the user session, (8) whether the target user purchases the item before the end of the user session, (9) an amount of the item that the target user places in the shopping cart, (10) an amount of the item that the target user purchases, (11) an average time the target user spent on each user session, (12) a click-through rate of the target user indicating a number or ratio of suggested content that the target user had clicked through, (13) how often the target user explores or purchases a new product or a product of a new brand in the historical user sessions, or (14) how often the target user explores or purchases a new product or a product of a new brand from a particular retailer.

18. The computer program product of claim 16, wherein the data associated with the current user session of the target user comprise at least one of (1) a search query entered by the target user during the current user session, (2) a variety of content browsed by the target user during the current user session, or (3) a variety of items that are placed in a shopping cart by the target user.

19. The computer program product of claim 11, wherein displaying the first set of recommendations to the user comprises:
receiving a search query from the user;
selecting one or more recommendations based on a relevance to the received search query; and
displaying the selected one or more recommendations in connection with a set of search results responsive to the search query.

20. A computer system comprising:
a processor; and
a non-transitory computer readable storage medium having instructions encoded thereon that, when executed by the processor, cause the processor to:
identify an opportunity to present content to a target user;
responsive to identifying the opportunity to present content to the target user, access a machine learning model trained on a dataset containing input features of a plurality of users and labels indicating openness metrics of the respective plurality of users, wherein training the machine learning model comprises: for each users,
display a first set of recommendations to the user, where the first set of recommendations are selected based on their contextual relevance;
compute a first response rate to the first set of recommendations;
display a second set of recommendations to the user, where the second set of recommendations are not selected based on their contextual relevance;
compute a second response rate to the second set of recommendations;
compute an openness metric that is a function of a difference between the first response rate and the second response rate, the openness metric indicating a loss in the user's response rate when contextual relevance is not considered in selection of a recommendation for the user; and
label the user with the openness metric; and
train the machine learning model on labels corresponding to the openness metrics of the plurality of users and their respective sets of input features;
apply the machine learning model to a set of features of the target user to output an openness metric that predicts a loss in the target user's response rate when contextual relevance is not considered in selection of recommendation for the target user;
select a recommendation from a plurality of candidate recommendations based on the openness metric; and
send the selected recommendation for display to the target user.
